(19) United States
(12) Patent Application Publication
(10) Pub. No.: US 2014/0349163 A1
(43) Pub. Date: Nov. 27, 2014

(54) BATTERY PACK

(71) Applicant: Samsung SDI Co., Ltd., Yongin-city (KR)

(72) Inventor: Jaeseung Kim, Yongin-City (KR)

(73) Assignee: Samsung SDI Co., Ltd., Yongin-City (KR)

(21) Appl. No.: 14/016,811

(22) Filed: Sep. 3, 2013

(30) Foreign Application Priority Data
May 23, 2013 (KR) 10-2013-0058413

(51) Int. Cl. H01M 10/42; H01M 2/10

(52) U.S. Cl. CPC H01M 10/425; H01M 2/1061; H01M 2010/4271
USPC 429/121

(57) ABSTRACT

A battery pack is provided, which includes a battery cell including an electrode assembly, an electrode terminal electrically connected to the electrode assembly, and a case accommodating the electrode assembly, and a protective circuit module including a first connection lead having one side electrically connected to the electrode terminal, a first connection part having the other side electrically connected to the first connection lead, and a second connection lead electrically connected to the case, wherein an area of the first connection part is larger than that of the other side of the first connection lead.

### CROSS-REFERENCE TO RELATED APPLICATION

This application claims priority to and the benefit of Korean Patent Application No. 10-2013-0058413, filed on May 23, 2013, the entire content of which is incorporated herein by reference.

### BACKGROUND

1. Field

Embodiments of the present invention relate to a battery pack.

2. Description of the Related Technology

A lithium secondary battery is formed in a configuration of a battery pack, which includes a battery cell and circuit devices, such as charge/discharge devices and a protection circuit device. The battery pack further includes a protective circuit module coupled to the battery cell and an external cover covering the protective circuit module.

The conventional battery pack is configured by forming a protective circuit module to be suited to the size of each battery cell. That is to say, one protective circuit module is manufactured per battery cell. In this case, it is necessary to newly design and manufacture a protective circuit module according to the width and thickness of the battery cell, which may increase a manufacturing time and financial costs.

### SUMMARY OF CERTAIN INVENTIVE ASPECTS

Embodiments of the present invention provide a battery pack including a protective circuit module compatibly used, irrespective of the size of a battery cell used.

According to an embodiment of the present invention, a battery pack is provided, including a battery cell including an electrode assembly, an electrode terminal electrically connected to the electrode assembly, and a case accommodating the electrode assembly, and a protective circuit module including a first connection lead having a first side electrically connected to the electrode terminal, a first connection part electrically connected to a second side of the first connection lead, and a second connection lead electrically connected to the case, wherein an area of the first connection part is larger than that of the other side of the first connection lead.

The first connection part may have a larger area than the other side of the first connection lead.

The first connection part may have a larger length than the second side of the connection lead.

The first connection part may include a plurality of connection terminals spaced a predetermined distance apart from each other and arranged in a line.

The second side of the first connection lead may be electrically connected to one or more of the plurality of connection terminals.

The first connection part may be shaped as a bar.

The first connection part may be shaped as a line bent at least one or more times in a direction parallel to one surface of the protective circuit module.

The first connection part may be formed on a bottom surface of the protective circuit module.

One side of the first connection lead may be longer than the electrode terminal.

A terminal hole having a predetermined length may be formed in the protective circuit module, and the terminal hole is longer than the electrode terminal.

The terminal hole may correspond to at least a portion of each of one side of the first connection lead and the electrode terminal.

The first connection lead may include a first lead plate electrically connected to the first connection part, a second lead plate bent from the first lead plate, and a third lead plate bent from the second lead plate and electrically connected to the electrode terminal.

The first connection part may be formed on a top surface of the protective circuit module.

A terminal hole may be formed in the protective circuit module, the second lead plate passes through the terminal hole, and the third lead plate may correspond to the terminal hole.

As described above, the present invention can provides a battery pack including a protective circuit module compatibly used, irrespective of the size of a battery cell used.

Additional aspects and/or advantages of the invention will be set forth in part in the description which follows and, in part, will be obvious from the description, or may be learned by practice of the invention.

### BRIEF DESCRIPTION OF THE DRAWINGS

The objects, features and advantages of the present invention will be more apparent from the following detailed description in conjunction with the accompanying drawings, in which:

FIG. 1 is a perspective view of a battery pack according to an embodiment of the present invention;

FIG. 2 is an exploded perspective view of the battery pack shown in FIG. 1;

FIG. 3 is a top view of a protective circuit module according to an embodiment of the present invention;

FIG. 4 is a perspective view illustrating a reversed state of the protective circuit module shown in FIG. 3;

FIG. 5 is a partially cross-sectional view illustrating a protective circuit module and a battery cell connected according to an embodiment of the present invention;

FIG. 6 is a perspective view illustrating a reversed state of a protective circuit module according to another embodiment of the present invention;

FIG. 7 is a perspective view of a battery pack according to still another embodiment of the present invention; and

FIG. 8 is a partially cross-sectional view illustrating a protective circuit module and a battery cell connected according to still another embodiment of the present invention.

### DETAILED DESCRIPTION OF CERTAIN INVENTIVE EMBODIMENTS

Hereinafter, embodiments of the present invention will be described in detail with reference to the accompanying drawings.

The present invention may be embodied in many different forms and should not be construed as being limited to the embodiments set forth herein. Rather, these embodiments of the invention are provided so that this disclosure will be thorough and complete and will fully convey the concept of the invention to those skilled in the art, and the present invention will only be defined by the appended claims.

In the drawings, the thickness of layers and regions are exaggerated for clarity. Here, like reference numerals refer to like elements throughout. As used herein, the term “and/or” includes any and all combinations of one or more of the associated listed items.

In addition, the terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various members, elements, regions, layers and/or parts, these members, elements, regions, layers and/or parts should not be limited by these terms. These terms are only used to distinguish one element from another member, element, region, layer and/or part. Thus, for example, a first member, a first element, a first region, a first layer and/or a first part discussed below could be termed a second member, a second element, a second region, a second layer and/or a second part without departing from the teachings of the present invention.

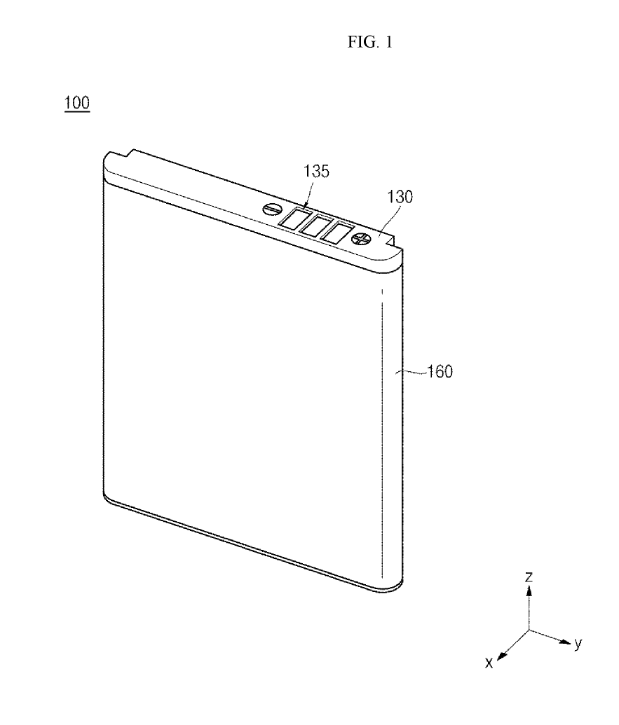

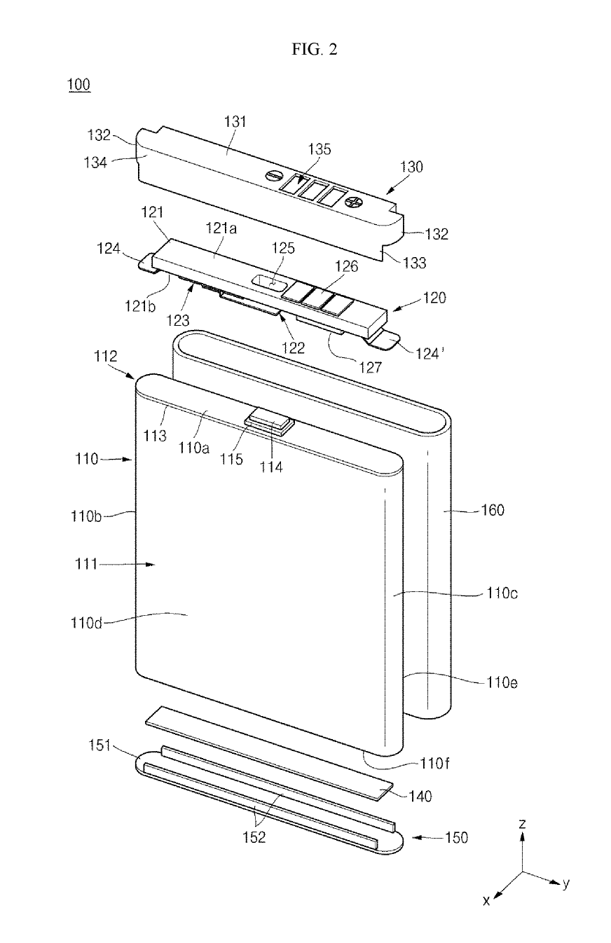

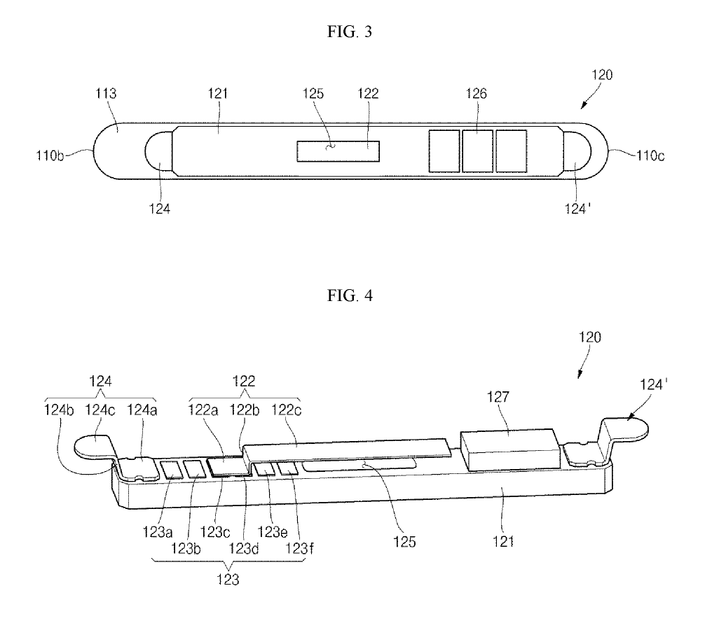

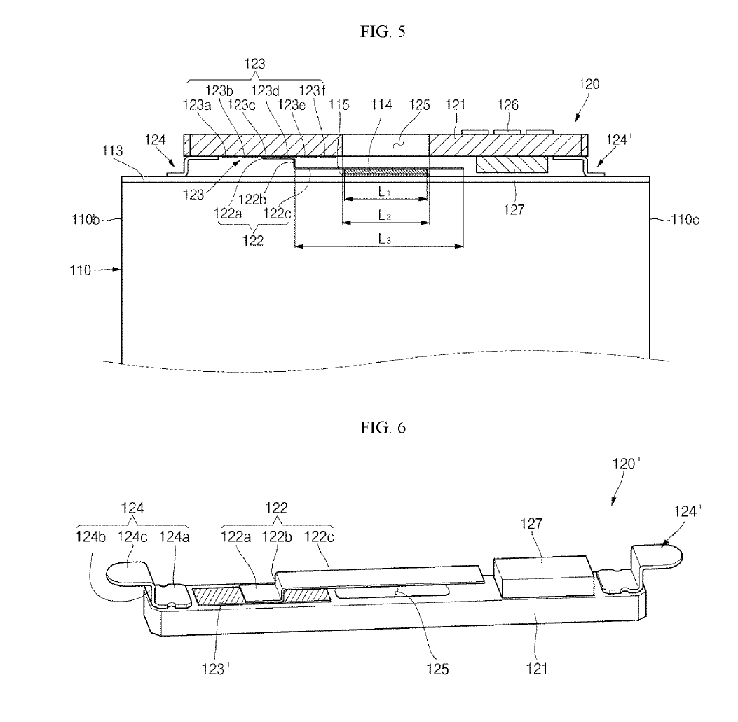

FIG. 1 is a perspective view of a battery pack (100) according to an embodiment of the present invention, FIG. 2 is an exploded perspective view of the battery pack (100) shown in FIG. 1, FIG. 3 is a top view of a protective circuit module (120) according to an embodiment of the present invention, FIG. 4 is a perspective view illustrating a reversed state of the protective circuit module (120) shown in FIG. 3, and FIG. 5 is a partially cross-sectional view illustrating a protective circuit module (120) and a battery cell (110) connected according to an embodiment of the present invention.

Referring to FIGS. 1 to 5, the battery pack 100 according to the embodiment of the present invention includes a battery cell 110, a protective circuit module 120, an upper cover 130 and a lower cover 150. In addition, when necessary, an adhesion member 140 may further be provided between the battery cell 110 and the lower cover 150.

The battery cell 110 may include an electrode assembly (not shown), a case 111 and a cap assembly 112. The electrode assembly (not shown) supplies electric energy and may include a positive electrode, a negative electrode and a separator interposed between the positive and negative electrodes. The case 111 is made of a metal and may accommodate the electrode assembly and an electrolytic solution (not shown). The cap assembly 112 may include a cap plate 113, an electrode terminal 114 and a gasket 115. The cap plate 113 may seal an opening of the case 111 and may be made of a metal. The electrode terminal 114 is formed to protrude from the cap plate 113. The gasket 115 is interposed between the cap plate 113 and the electrode terminal 114 and insulates the electrode terminal 114 from the cap plate 113.

The case 111 or the cap plate 113 may serve as a positive electrode or a negative electrode. The embodiment of the present invention will be described by way of example with regard to a case where the case 111 or the cap plate 113 serves as a positive electrode. Accordingly, in the following description of the embodiment of the present invention, it is assumed that the electrode terminal 114 serves as a negative electrode having an opposite polarity to that of the case 111. Here, the case 111, the cap plate 113 and the electrode terminal 114 may have different polarities.

The battery cell 110 is insulated from the gasket 115 and may include a top surface 110a from which the electrode terminal 114 protrudes, a pair of short side surfaces 110b and 110c and a pair of long side surfaces 110d and 110e, which are connected to the top surface 110a, and a bottom surface 110f connected to the respective side surfaces 110b, 110c, 110d and 110e and facing the top surface 110a. The pair of short side surfaces 110b and 110c are narrow side surfaces among the side surfaces 110b, 110c, 110d and 110e connected to the top surface 110a of the battery cell 110, and the pair of long side surfaces 110d and 110e are wide side surfaces among the side surfaces 110b, 110c, 110d and 110e of the battery cell 110.

The protective circuit module 120 is positioned on the battery cell 110 and is electrically connected to the battery cell 110. The protective circuit module 120 may include a protective circuit board 121, a first connection lead 122, a first connection part 123, second connection leads 124 and 124′, a terminal hole 125, an external terminal part 126 and a protective circuit device 127.

The protective circuit board 121 is shaped of a plate made of a resin and has a top surface 121a and a bottom surface 121b. In the present invention, it is assumed that the top surface 121a of the protective circuit board 121 corresponds to a top surface of the protective circuit module 120 and the bottom surface 121b of the protective circuit board 121 corresponds to a bottom surface of the protective circuit module 120. Meanwhile, the first connection part 123 to be described later is formed on the bottom surface of the protective circuit board 121 and forms a predetermined region connected to the first connection lead 122. The first connection part 123 will later be described in more detail.

One side of the first connection lead 122 is electrically connected to the electrode terminal 114 by resistance welding through the terminal hole 125, and the other side of the first connection lead 122 is electrically connected to the first connection part 123 installed on the bottom surface 121b of the protective circuit board 121, thereby being electrically connected to a negative wiring pattern (not shown) of the protective circuit module 120. The first connection lead 122 is made of a metal, such as nickel or a nickel alloy. Like the electrode terminal 114, the first connection lead 122 may serve as a negative electrode.

The first connection lead 122 may include first to third lead plates 122a, 122b and 122c. The first lead plate 122a is electrically connected to the first connection part 123. Here, a region formed by the first connection part 123 may be wider than the first lead plate 122a. For example, an area of the first connection part 123 may be smaller than that of the first lead plate 122a, or a length of the first connection part 123 may be larger than that of the first lead plate 122a. Alternatively, the first connection part 123 may satisfy the requirements of both of the area and the length stated above. The reasons of forming the first lead plate 122a and the first connection part 123 in such a manner as stated above will later be described with regard to the first connection part 123. The second lead plate 122b may be bent from the first lead plate 122a. For example, the second lead plate 122b may be bent from the first lead plate 122a to be perpendicular to the top surface 110a of the battery cell 110. The third lead plate 122c may be bent from the second lead plate 122b. For example, the third lead plate 122c may be bent from the second lead plate 122b to be perpendicular to the top surface 110a of the battery cell 110. Here, the third lead plate 122c may be formed to have a predetermined length. In more detail, the third lead plate 122c may be formed longer than the electrode terminal 114. The reasons of forming the third lead plate 122c and the electrode terminal 114 in such a manner as stated above will later be described with regard to the first connection part 123.

As shown in FIGS. 4 and 5, the first connection part 123 includes a plurality of connection terminals 123a, 123b, 123c, 123d, 123e and 123f. The embodiment of the present invention will be described by way of example with regard to a case where the first connection part 123 includes first to sixth connection terminals 123a, 123b, 123c, 123d, 123e and 123f, as shown in FIGS. 4 and 5. However, the present invention does not limit the number of connection terminals.

The first to sixth connection terminals 123a, 123b, 123c, 123d, 123e and 123f are spaced a predetermined distance apart from each other on the bottom surface 121c of the protective circuit board 121 and may be arranged in a line. In more detail, the first to sixth connection terminals 123a, 123b, 123c, 123d, 123e and 123f are sequentially arranged between ends of the protective circuit board 121, that is, between the second connection lead 124 and the terminal hole 125 of the protective circuit board 121. Here, the first connection terminal 123a may be installed to be closest to the second connection lead 124, and the sixth connection terminal 123f may be installed to be closest to the terminal hole 125.

Areas formed by the first to sixth connection terminals 123a, 123b, 123c, 123d, 123e and 123f may be wider than an area formed by the first lead plate 122a of the first connection lead 122. For example, a total area and a length of the first to sixth connection terminals 123a, 123b, 123c, 123d, 123e and 123f are larger than an area and a length of the first lead plate 122a of the first connection lead 122, respectively. Here, a total length of the first to sixth connection terminals 123a, 123b, 123c, 123d, 123e and 123f means a length ranging from the first connection terminal 123a to the sixth connection terminal 123f, that is, a distance between connection terminals.

As described above, since the first connection part 123 is widely formed between the end of the protective circuit board 121 and the terminal hole 125, the first lead plate 122a of the first connection lead 122 having a relatively small length may be connected to the first connection part 123 at varying positions. For example, as shown in FIGS. 4 and 5, the first lead plate 122a of the first connection lead 122 is connected to the third and fourth connection terminals 123c and 123d, so that it may be connected at a middle area between the end of the protective circuit board 121 and the terminal hole 125. In addition, although not shown, the first lead plate 122a of the first connection lead 122 is connected to the first and second connection terminals 123a and 123b, so that it may be connected to a position adjacent to the end of the protective circuit board 121. In addition, the first lead plate 122a of the first connection lead 122 is connected to the fifth and sixth connection terminals 123e and 123f, so that it may be connected to a position adjacent to the terminal hole 125.

In addition, since the first lead plate 122a of the first connection lead 122 is also connected to the second and third connection terminals 123b and 123c, to the third and fourth connection terminals 123c and 123d or to the fourth and fifth connection terminals 123d and 123f, positions for connection between the first connection lead 122 and the first connection part 123 may vary in step-by-step manner.

In the above-described embodiment, the first lead plate 122a of the first connection lead 122 has been described that it is connected to two adjacent connection terminals, but aspects of the present invention are not limited thereto. That is to say, the first lead plate 122a may be connected to one or more connection terminals, and connected positions of the first connection lead 122 may vary between the end of the protective circuit board 121 and the terminal hole 125 step by step, which is one of essential features of the present invention.

In connecting a protective circuit module and a battery cell to each other, the protective circuit module is generally connected to the battery cell at a particular position of a top surface of the battery cell as a standard point for connection. In more detail, one of two second connection leads 124 and 124′ of the protective circuit module 120 is connected to a position spaced a predetermined distance apart from one of the short side surfaces 110b and 110c of the top surface 110a of the battery cell 110. Here, the position becomes a standard point for connection between the protective circuit module 120 and the battery cell 100. In addition, the first connection part 123 of the protective circuit module 120 connected to the first connection lead 122 is formed only at a particular position in consideration of a position where the electrode terminal of the battery cell 110 is formed. Thus, if the conventional battery cell becomes bulky, the protective circuit module 120 should be newly designed by changing the position of the first connection lead 122 to be adapted to the position where the electrode terminal of the battery cell 110 is formed. Here, the size of the battery cell 110 is defined as a distance between the short side surfaces 110b and 110c of the battery cell 110. If a protective circuit module formed not to fit into the size of a battery cell is used, a distance between the first connection lead mounted on the protective circuit module and the electrode terminal of the battery cell may become too small or large to come into contact with each other, making it difficult to weld the first connection lead to the electrode terminal.

However, according to the embodiment of the present invention, since an area forming the first connection part 123 is wider than the first lead plate 122a of the first connection lead 122, the position of the first lead plate 122a connected may vary, thereby compatibly using one protective circuit module 120, irrespective of the size of the battery cell 110.

For example, as shown in FIG. 5, it is assumed that a position of the top surface 110a of the battery cell 110 connected to the second connection lead 124 installed in the left of the protective circuit module 120 is a standard point for connection of the protective circuit module 120. Here, the first lead plate 123a of the first connection lead 123 is connected to the third and fourth connection terminals 123c and 123d of the first connection part 122. If the battery cell 110 becomes bulky, the electrode terminal 114 is shifted to the right from the standard point for connection. In this case, if the first lead plate 122a is connected to the fifth and sixth connection terminals 123e and 123f of the first connection part 122, the first connection lead 122 is shifted toward the electrode terminal 114, thereby securing a sufficiently wide contact area between the third lead plate 122c and the electrode terminal 114, irrespective of relative movement of the position of the electrode terminal 114.

If the battery cell 110 is reduced in size, the electrode terminal 114 is shifted to the left from the standard point for connection. In this case, if the first lead plate 122a is connected to the first and second connection terminals 123a and 123b of the first connection part 122, the first connection lead 122 is shifted toward the electrode terminal 114, thereby securing a sufficiently wide contact area between the third lead plate 122c and the electrode terminal 114, irrespective of relative movement of the position of the electrode terminal 114.

With this configuration, however, in the embodiment of the present invention, in order to provide a sufficient space for resistance welding of the third lead plate 122c and the electrode terminal 114, a length L2 of the terminal hole 125 is made longer than a length L1 of the electrode terminal 114. Therefore, the terminal hole 125 has a sufficiently wide area corresponding to the electrode terminal 114, thereby securing a more space for welding the third lead plate 122c to the electrode terminal 114.

In addition, a length L3 of the third lead plate 122c of the first connection lead 122 may be made longer than the length of the electrode terminal 114. In this case, since the length L3 of the third lead plate 122c is within a movement range of the electrode terminal 114, when necessary, a sufficiently wide contact area between the third lead plate 122c and the electrode terminal 114 can be secured even without moving the first connection lead 123.

In the above-described embodiment, the first connection part 123 is divided into multiple parts. Alternatively, the first connection part 123 may be embodied in various manners other than in the embodiment illustrated herein.

FIG. 6 is a perspective view illustrating a reversed state of a protective circuit module according to another embodiment of the present invention.

As shown in FIG. 6, the first connection part 123′ is shaped of a bar extending from the second connection lead 124 toward the terminal hole 125 or from the terminal hole 125 toward the second connection lead 124, thereby changing positions of the first connection lead 122 step by step.

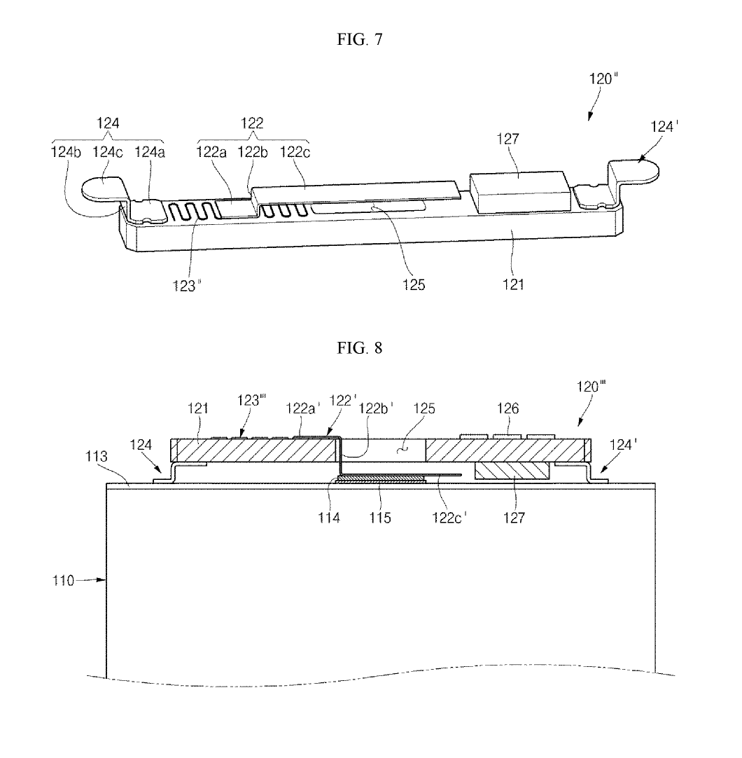

FIG. 7 is a perspective view of a battery pack according to still another embodiment of the present invention.

As shown in FIG. 7, the first connection part 123″ is shaped of a line bent at least one or more times in a direction parallel to a bottom surface of the protective circuit module 120″, and extends from the second connection lead 124 toward the terminal hole 125 or from the terminal hole 125 toward the second connection lead 124, thereby changing positions of the first connection lead 122 step by step.

As shown in FIG. 8, the protective circuit module 120′″ may include a protective circuit board 121, a first connection lead 122′, a first connection part 123′″, second connection leads 124 and 124′, a terminal hole 125, an external terminal part 126 and a protective circuit device 127. Here, the protective circuit board 121, the second connection leads 124 and 124′, the terminal hole 125, the external terminal part 126 and the protective circuit device 127 are substantially the same as the corresponding components of FIG. 1, and detailed descriptions thereof will be omitted.

However, the protective circuit module 120′″ according to the present embodiment is different from the protective circuit module 120 according to the previous embodiment, in view of configurations of a first connection lead 122′ and a first connection part 123′″. The first connection lead 122′ may include first to third lead plates 122a′, 122b′ and 122c′ and is structurally similar to the first connection lead 122 according to the previous embodiment. However, unlike in the previous embodiment, the first connection part 123′″ is installed on a top surface 121a of the protective circuit board 121. Accordingly, the first lead plate 122a of the first connection lead 122′ electrically connected to the first connection part 123′″ is positioned on a top surface of the protective circuit board 121, and the second lead plate 122b′ passes through the terminal hole 125 to be positioned under the protective circuit board 121 of the third lead plate 122c′. Here, the third lead plate 122c′ corresponds to the terminal hole 125 and is electrically connected to the electrode terminal 114 by resistance welding through the terminal hole 125.

Meanwhile, as shown in FIGS. 4 and 5, the first connection part 123′″ may be divided into multiple connection parts. As shown in FIGS. 6 and 7, the first connection part 123′″ may be shaped of a bar or a meander line.

The second connection leads 124 and 124′ may be provided in pair. One side of each of the second connection leads 124 and 124′ is coupled to a bottom surface of opposite ends of the protective circuit board 121 to be electrically connected t0 a positive wiring pattern of the protective circuit module 120 and the other side of each of the second connection leads 124 and 124′ extends toward the top surface 110a of the battery cell 110 to then be coupled to the top surface 110a of the battery cell 110 by, for example, resistance welding. Accordingly, the second connection leads 124 and 124′ are electrically connected t0 the battery cell 1100 and the protective circuit module 120. The second connection leads 124 and 124′ are made of a metal, such as nickel or a nickel alloy. Here, like the top surface 110a of the battery cell 110, that is, the cap plate 113, the second connection leads 124 and 124′ may serve as a positive electrode. As described above, like the case 111, the cap plate 113 may also serve as a positive electrode.

The terminal hole 125 is formed to pass through top and bottom surfaces 121a and 121b of the protective circuit board 121. The terminal hole 125 is formed to pass through a roughly central portion of the protective circuit board 121, but not limited thereto. The terminal hole 125 is preferably formed at a region corresponding to the electrode terminal 114 of the battery cell 110. The terminal hole 125 provides a space for welding the second lead plate 122c to the electrode terminal 114. As described above, a length L2 of the terminal hole 125 is made longer than a length L1 of the electrode terminal 114. Therefore, the terminal hole 125 has a sufficiently wide area corresponding to the electrode terminal 114, thereby securing a more space for welding the third lead plate 122c to the electrode terminal 114.

An external terminal part 126 is installed on the top surface 121a of the protective circuit board 121 and is electrically connected to the protective circuit board 121 and an external electronic device (not shown).

The protective circuit device 127 is formed on the bottom surface 121b of the protective circuit board 121 and includes charge/discharge circuits and a protection circuit. The protective circuit device 127 is connected between a positive wiring pattern (not shown) and a negative wiring pattern (not shown) of the protective circuit module 120 and may perform charging and discharging operations and over-charging and over-discharging operations of the battery cell 110.

An upper cover 130 is coupled to a top portion of the battery cell 110 and accommodates the protective circuit module 120 in its inner space. The upper cover 130 may include an upper cover plate 131, and sidewalls 134 extending from the upper cover plate 131 toward the protective circuit module 120.

The upper cover plate 131 is formed to have substantially the same shape as that of a top surface 113a of the battery cell 110. An inner surface of the upper cover plate 131 may face and come into contact with the top surface 121a of the protective circuit board 121. The upper cover plate 131 includes a throughhole 135 formed at a region corresponding to the external terminal part 126 of the protective circuit module 120. The throughhole 135 exposes the external terminal part 126 to the outside, thereby electrically connecting the battery pack 100 to a set or a charge/discharge device.

The sidewalls 134 include opposite ends 132 positioned at ends in a lengthwise direction of the upper cover 130 and a connection part 133 connecting the opposite ends 132. The opposite ends 132 contact regions of the top surface 110a of the battery cell 110 corresponding to short side surfaces 110b and 110c on and support the upper cover 130. The connection part 133 further extends toward the protective circuit module 120 than the opposite ends 132. A portion of the connection part 133, covering top portions of a pair of long side surfaces 110d and 110e of the battery cell 110 is surrounded by a label 160.

An adhesion member 140 may be interposed between a bottom surface of the battery cell 110 and a lower cover 150. The adhesion member 140 adheres the battery cell 110 to the lower cover 150 and may stably maintain a state in which the battery cell 110 and the lower cover 150 are adhered to each other. The adhesion member 140 may be provided as an adhesive paste or a tape. However, the adhesion member 140 may not be provided as long as the lower cover 150 is shaped to surround at least some portions of side surfaces 110b, 110c, 110d and 110e of the battery cell 110 to be physically connected to the battery cell 110.

The lower cover 150 is coupled to the bottom surface of the battery cell 110 from below the battery cell 110. The lower cover 150 includes a lower cover plate 151 contacting the bottom surface of the battery cell 110 and a cell support unit 152 upwardly protruding from the lower cover plate 151 toward the battery cell 110

The lower cover plate 151 has substantially the same shape as the bottom surface 110f of the battery cell 110 and is coupled to contact the bottom surface 110f of the battery cell 110. In a case where the adhesion member 140 is provided, the lower cover plate 151 may be attached to a bottom surface of the adhesion member 140.

The support unit 152 may be provided in pair and may be formed at edges of the lower cover plate 151 along long sides of the lower cover plate 151. That is to say, the cell support unit 152 is coupled to the battery cell 110 while covering lower portions of the long side surfaces 110d and 110e of the battery cell 110. The cell support unit 152 is wrapped by the label 160, thereby maintaining a state in which it is coupled to the battery cell 110. However, in a case where the adhesion member 150 is provided and the lower cover plate 151 is attached to the bottom surface 110f of the battery cell 110, the cell support unit 152 may not be provided at the discretion of one skilled in the art.

While the battery pack of the present invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A battery pack comprising:
a battery cell including an electrode assembly, an electrode terminal electrically connected to the electrode assembly, and a case accommodating the electrode assembly; and
a protective circuit module including a first connection lead having a first side electrically connected to the electrode terminal, a first connection part electrically connected to a second side of the first connection lead, and a second connection lead electrically connected to the case,
wherein an area of the first connection part is larger than that of the second side of the first connection lead.

2. The battery pack of claim 1, wherein the first connection part has a larger length than the second side of the connection lead.

3. The battery pack of claim 1, wherein the first connection part includes a plurality of connection terminals spaced a predetermined distance apart from each other and arranged in a line.

4. The battery pack of claim 3, wherein the second side of the first connection lead is electrically connected to one or more of the plurality of connection terminals.

5. The battery pack of claim 1, wherein the first connection part is shaped as a bar.

6. The battery pack of claim 1, wherein the first connection part is shaped as a line bent at least one or more times in a direction parallel to one surface of the protective circuit module.

7. The battery pack of claim 1, wherein the first connection part is formed on a bottom surface of the protective circuit module.

8. The battery pack of claim 1, wherein the first side of the first connection lead is longer than the electrode terminal.

9. The battery pack of claim 1, wherein a terminal hole having a predetermined length is formed in the protective circuit module, and the terminal hole is longer than the electrode terminal.

10. The battery pack of claim 9, wherein the terminal hole corresponds to at least a portion of each of one side of the first connection lead and the electrode terminal.

11. The battery pack of claim 1, wherein the first connection lead comprises:
a first lead plate electrically connected to the first connection part;
a second lead plate bent from the first lead plate; and
a third lead plate bent from the second lead plate and electrically connected to the electrode terminal.

12. The battery pack of claim 11, wherein the first connection part is formed on a top surface of the protective circuit module.

13. The battery pack of claim 11, wherein a terminal hole is formed in the protective circuit module, the second lead plate passes through the terminal hole, and the third lead plate corresponds to the terminal hole.

14. A battery pack comprising:
a battery cell that includes an electrode terminal and a case;
a protective circuit module that includes a first connection part and a first connection lead having a first and a second end, wherein the first end of the lead is attached to the electrode terminal of the battery cell and the second end is connected to the first connection part, wherein the first connection part is dimensioned so that the second end of the first connection lead can be attached to a first connection part over a range of positions.

15. The battery pack of claim 14, wherein the first connection part has a larger area than the second end of the first connection lead.

16. The battery pack of claim 14, wherein the first connection part comprises a plurality of connection terminals spaced a predetermined distance apart from each other to permit the second end of the first connection lead to be attached one or more of the plurality of connection terminals.

17. The battery pack of claim 14, wherein the connection part is shaped as a bar.

18. The battery pack of claim 14, wherein the first connection pat is shaped as a line bent one or more times in a direction parallel to one surface of the protection circuit module.

19. The battery pack of claim 14, wherein the first end of the first connection lead is longer than the electrode terminal so that lead can be attached to the electrode terminal over a range of positions.

20. The battery pack of claim 14, wherein the first connection part is formed on a top surface of the protection circuit module.
